(19) United States
(12) Patent Application Publication
(10) Pub. No.: US 2018/0345402 A1
(43) Pub. Date: Dec. 6, 2018

(54) Improved Apparatus for Use of Rotating Arc Process Welding

(71) Applicant: WELD REVOLUTION, LLC, Tomball, TX (US)

(72) Inventors: Michael S. WALL, Humble, TX (US); Eric M. CHRISTOFFERSON, Spring, TX (US); Randal S. FUNDERBURK, Magnolia, TX (US)

(21) Appl. No.: 15/571,836

(22) PCT Filed: May 8, 2015
(86) PCT No.: PCT/US15/29828

§ 371 Date: Nov. 5, 2017

(51) Int. Cl. B23K 9/30; B23K 9/173; B23K 9/29; B23K 9/32

(52) U.S. Cl. CPC B23K 9/30; B23K 9/32; B23K 9/295; B23K 9/173

(57) ABSTRACT

An improved arc welding apparatus that imparts a rotational movement to the contact tip of the consumable electrode to cause molten metal to be deposited by centrifugal force against the surface of the metal work pieces being welded. The welding apparatus being configurable to control the deposit patterns of the molten welding materials.

### CROSS-REFERENCE TO RELATED APPLICATIONS

Not applicable

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO SEQUENCE LISTING, A TABLE, OR A COMPUTER PROGRAM LISTING APPENDIX SUBMITTED ON COMPACT DISC

Not applicable.

### BACKGROUND OF THE INVENTION

The present invention relates to improvements to arc welding torch where lateral movement is imparted to the arcing end of the electrode in a controlled and continually adjustable manner. More specifically, improvements to the control of the movement imparted to the arching end of the electrode, and other operational aspects of arc torch operations.

Differing conditions make adjustments necessary to achieve optimum results in the welding process. In some environments, conditions may change during the course of a single weld operation. It is desirable for a torch to be re-configurable rather than requiring multiple torches. It is also desirable for adjustments to be made during the course of a single task as conditions vary in material, angle, or even surrounding environment.

Applicant has previously discussed difficulties appreciated by those skilled in the arts, and the Applicant's previous contributions to the industry with respect to aspects of rotational arc welding in PCT/US13/049700, a P.C.T. application filed in the U.S. receiving office on 09 Jul. 2013, incorporated herein in its entirety by reference.

### BRIEF DESCRIPTION OF THE DRAWINGS

With the foregoing and other objects in view, all of which more fully hereinafter appear, our invention comprises certain combinations, constructions and arrangement of parts and elements, and operations, sequences and steps, all as hereinafter described, defined in the appended claims and illustrated in preferred embodiment in the accompanying drawings in which:

FIG. 1 is a diagrammatic elevational view of a continuous arc welding apparatus as previously disclosed by the applicant in previous applications.

FIG. 2 is a diagrammatic elevational view of a continuous arc welding apparatus incorporating therein the improvements in accordance with an exemplary embodiment of the invention.

FIG. 3 is a sectional elevational view of a portion of the torch body showing the improved rotor head assembly and flexure assembly in accordance with an exemplary embodiment of the invention.

FIG. 4A is a sectional perspective view of the major components of the rotor head assembly in accordance with an exemplary embodiment of the invention.

FIG. 4 is an exploded perspective view of the rotor head assembly in accordance with an exemplary embodiment of the invention.

FIG. 5 is a perspective view of the flexure component in accordance with an exemplary embodiment of the invention.

FIG. 6 is a perspective sectional view of a portion of the torch body showing the improved flexure assembly in accordance with an exemplary embodiment of the invention.

FIG. 7 shows exemplary control signals and their respective effect on the contact tip rotation patterns in accordance with an exemplary embodiment of the invention.

### DETAILED DESCRIPTION OF THE INVENTION AND THE PREFERRED EMBODIMENTS

The present invention extends the state of the art beyond that disclosed in our previous patents. Improvements involve toolless adjustment capabilities, improved design features and usability enhancements, and external control capabilities.

In prior designs, the width of the rotational path was controlled by varying the speed and direction of an electronic motor to increase or decrease the centrifugal force, or varying the length of the rotating contact tip through a swap and replace of the wand component. In the improved design, a rotor head assembly is comprised of a plurality of mating cylindrical components with offset axis and an opening through which the electrode passes. The components are rotated with respect to one another and locked into varying alignments which adjust the distance of the electrode opening from true center. This deflection of the electrode results in a change in the width of the contact tip's rotational path.

In the preferred embodiment, the rotor head assembly is manually rotated, and held in alignment through the lower rotor head component's locking pins/ball plungers which are urged via a springing component into a plurality of holes or divots in the upper rotor head component. Manually twisting the upper rotor head component thus adjusts the width of the contact tip's rotational path without the need for tools or the swapping of parts. In another embodiment, the rotation of the rotor head assembly and deflection of the electrode is accomplished via a mechanized component such as a stepper motor, solenoid, or voice-coil actuator. This allows for finer control of the contact tip's rotational path in an automated fashion.

In one embodiment, the mechanized control is connected to a computing device which further interfaces with sensors on or near the tip of the torch. The sensors detect the weld environment and adjust the torch in response to changing conditions. The sensors may be cameras and video processors, or measure the changes in the arc lighting, or heat sensors, or wind flow sensors.

A further improvement in the apparatus is the incorporation of an active electronic control and monitoring device. The previous electronics would provide signals (stepper or servo) to the motor for rotation, and would allow speed and direction control. The improved control device allows greater control over the motor such as spin delay, programmed spin patterns, digital feedback, monitoring of sensors and torch system feedback, and automated or preprogrammed responses.

The previous electronics would generate a passive signal to the motors targeting operation at certain revolutions per minute (RPM). The improved system monitors the motor's actual progress and adjusts output to maintain the required RPM, or to record and report the discrepancy there between. Many means of measuring a motor's speed and performance are known by those skilled in the arts, and no specific motor measuring apparatus, process, or method are claimed by the patent. Therefore, further details are not necessary in this specification.

The improved system allows programmed motor control signals which are customized to produce a desired spin. By varying the motor control signal, different patterns can be achieved in the tip's impelling of molten metal material. For instance, a steady control signal during rotation will generate a circular tip rotation pattern and an even deposit of material. Increasing the signal strength will increase the diameter of the rotational pattern and widen the material dispersal area. Adding a sharp increase in the control signal in phase with the motor's rotation such that the increase is cycled at the same motor position each revolution, will result in an increase in tip's force in a relevant direction and thus more material deposited in that direction. This is useful because a horizontal weld on a vertical surface can program the apparatus to impel more material to the upper side of the weld to counteract slumping toward the bottom of the weld channel.

The improvements further comprise a flexure in place of the braided copper wires and spherical bearings of the previous design. The flexure provides the flexible physical support of the electrode, allowing shielding gas to pass through, and providing an electrical contact sufficient to handle the large currents necessary in welding applications. The flexure is a disc shaped component of conductive material. The disc comprises an inner and an outer ring, the rings are joined by a plurality of arms which extend inward from the outer ring, and curve partially around the circumference of the inner ring before attaching to the outer edge of the inner ring. The arching arms allow the inner ring to flex so its plane may not be parallel to that of the outer ring.

The space between the arms allows shielding gas to pass through the flexure. The cross section of the arms is balanced between the opening size necessary for sufficient quantities of shielding gas to pass through the flexure, and the amount of arm material necessary to conduct sufficient electricity between the rings for proper welding. The joints between the arms and the rings are filleted to encourage flexure to occur in the arms.

The flexure design allows shielding gas to flow through the body of the welding torch. This means gas passes around the motor of the torch, adding cooling to the motor and the handle. This improved cooling along with the isolated outer body and a heat shield boot, allow the torch to be comfortably held for manual welding. It also reduces the complexities of counting and operating in mechanized or automated operations.

Another improvement in the apparatus includes separating the wand tip into multiple components, as the end of the wand closest to the weld may become damaged in the harsh environments. Replacing the end of the wand assembly rather than the entire wand is easier and less costly. Additionally, this allows the end of the wand to be extended or shortened by using different wand ends for different environments, allowing for further customization of the apparatus.

In another embodiment, the wand of the torch can be lengthened with one or more extensions. Adding extensions also requires the gas shielding nozzle be extended and possibly shaped differently to accommodate the movement of the tip, which will be exaggerated due to the longer wand.

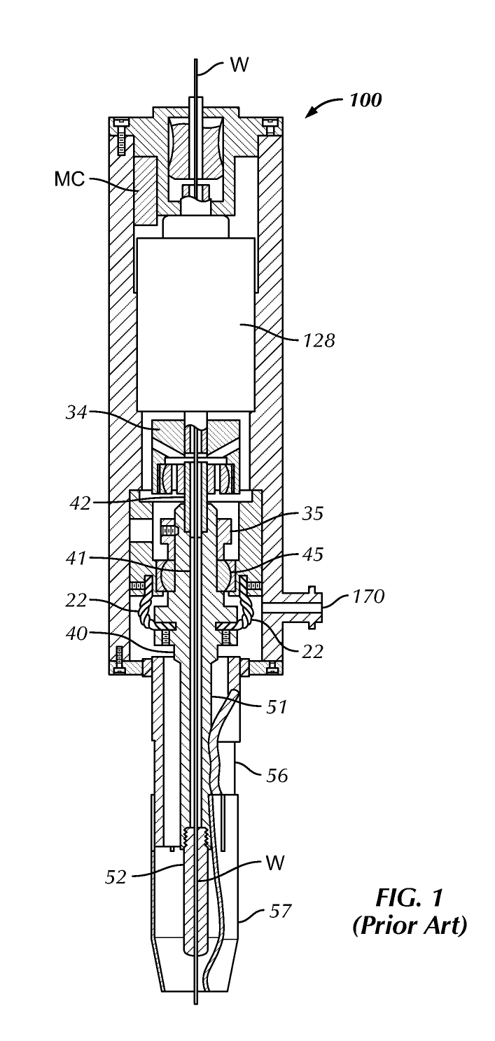

FIG. 1 is a diagrammatic elevational view of a continuous arc welding apparatus as previously disclosed by the applicant in previous applications. The wire (W) passes through the welding torch along an axial passageway (41). The tubular bushing (42) guides the wire (W) from the hollow shaft of the motor (128) to the wand, (40) all of which comprises the axial passageway (41). The motor (128), controlled by the integrated motor control (MC), mates with the rotor head (34) and imparts a rotational movement to the wand (40) which the eccentric spherical bearing (35) translates into a rotational movement at the welding contact tip (52) of the torch (100) through the spherical rocker bearing (45), which works as a fulcrum to the wand (40). Wire braids (22) are flexible to allow movement of the wand (40) and also conduct current thereto for the welding process. Shielding gas enters the torch (100) via the gas supply connector port (170) and exits down through the lower tube (56) and the gas shielding nozzle (57), which surrounds the welding contact tip (52).

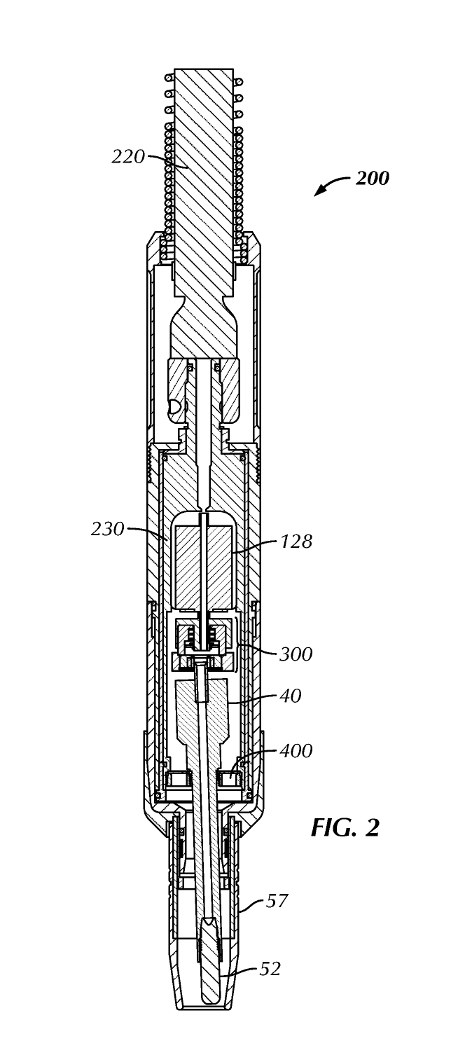

FIG. 2 is a diagrammatic elevational view of a continuous arc welding apparatus incorporating therein the improvements in accordance with an exemplary embodiment of the invention. The integrated cable assembly (20) enters the upper end of the improved torch (200). The integrated cable assembly (220) carries the wire (W, not indicated) motor control signals on a plurality of wires and shielding gas. Bringing the motor control signals through the integrated cable assembly (220) eliminates the integrated motor control (MC, FIG. 1) which allows for more complex control of the system through the integration of additional sensors and processing capability as well as additional feedback to the operator. Bringing the shielding gas through the integrated cable assembly (220) and allowing it to pass through the annular gas cavity (230) eliminates the side mounted gas supply connector port (170, FIG. 1), which off balanced the torch and made it more difficult to control with precision.

In the improved torch (200), the wire (W, not indicated) still passes through a hollow shaft of the motor (128), but then passes through a rotor head assembly (300) which imparts rotational fluctuation by eccentric rotational movement to the wand (40). The wand is supported by a flexure assembly (400) which is configured to allow the rational sway that causes the rotational movement of the contact tip (52) in the gas shielding nozzle (57).

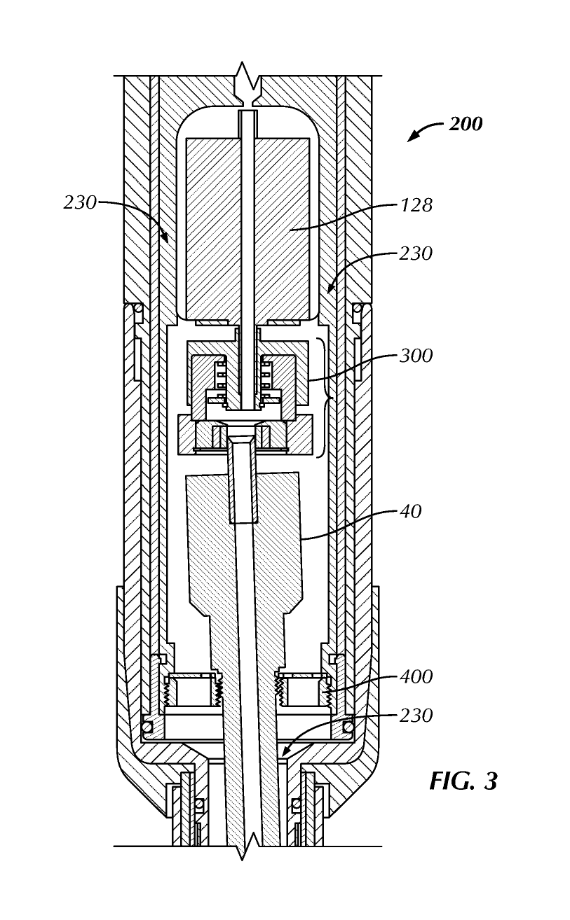

FIG. 3 is a sectional elevational view of a portion of the torch body showing the improved rotor head assembly and flexure assembly in accordance with an exemplary embodiment of the invention. The enlarged view shows the annular gas cavity (230) passing around the motor (128), rotor head assembly (300) and wand (40). The flexure (400) is configured to allow gas to pass through.

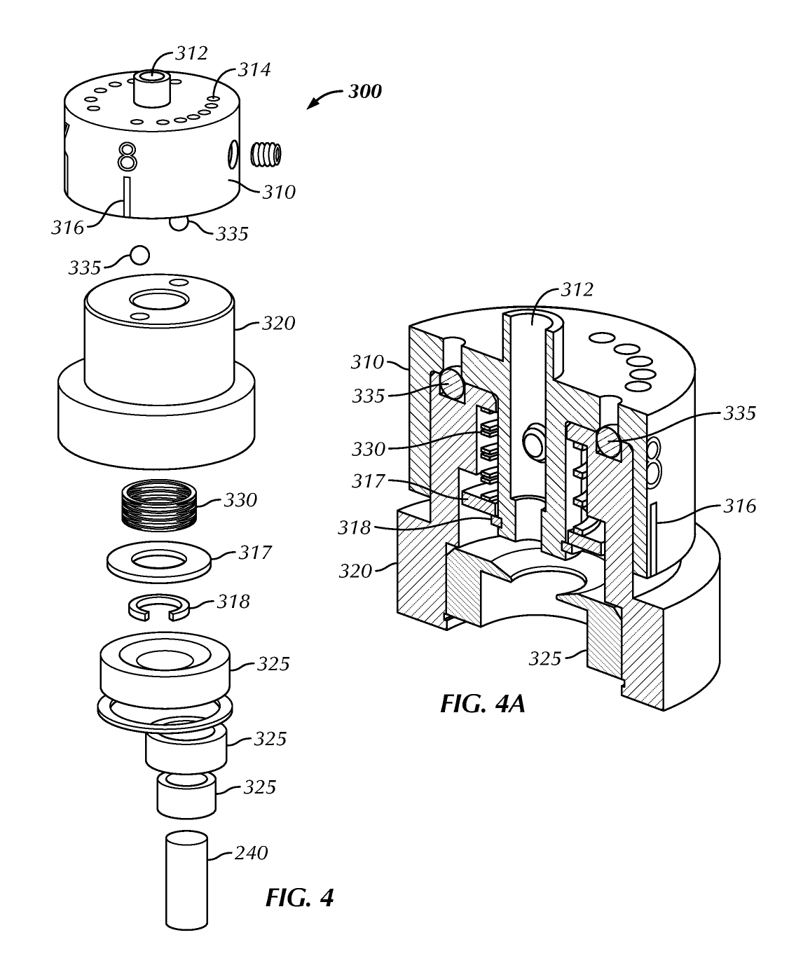

FIG. 4A is a sectional perspective view of the major components of the rotor head assembly in accordance with an exemplary embodiment of the invention. The rotor head assembly (300) comprises the upper rotor head component (310) and the lower rotor head component (320). The two are joined by a spring (330) which surrounds the wire guide hole (312) and is held into place by a retaining washer (317) and a retaining ring (318), forcing the locking ball pins (335) into the locking divots (314) of the upper rotor head component (310). The rotor head components (310 & 320) are eccentric so that rotating them by twisting to force the locking bail pins (335) into different locking divots (314) offsets the wire guide hole by an amount indicated by the adjustment indicators (316). Miscellaneous bushings (325) further guide the wire out the bottom of the rotor head assembly (300) and into the tubular bushing (42, not shown).

FIG. 4 is an exploded perspective view of the crank assembly in accordance with an exemplary embodiment of the invention. The rotor head assembly (300) comprises the upper rotor head component, (310) and the lower rotor head component (320). The two are joined by a spring (330) which surrounds the wire guide hole (312) which extends through the body of the upper rotor head component (310) and contains a recessed groove for a retaining ring (318) which holds a retaining washer (317) to secure it into place, forcing the locking ball pins (335) into the locking divots or holes (314) of the upper rotor head component (310). The rotor head components (310 & 320) are eccentric so that rotating them by twisting to force the locking ball pins (335) into different locking divots (314) offsets the wire guide hole (312) by an amount indicated by the adjustment indicators (316). Miscellaneous bushings (325) further guide the wire out the bottom of the rotor head assembly (300) and into the tubular bushing (42) which extends into the top of the wand (40, not shown).

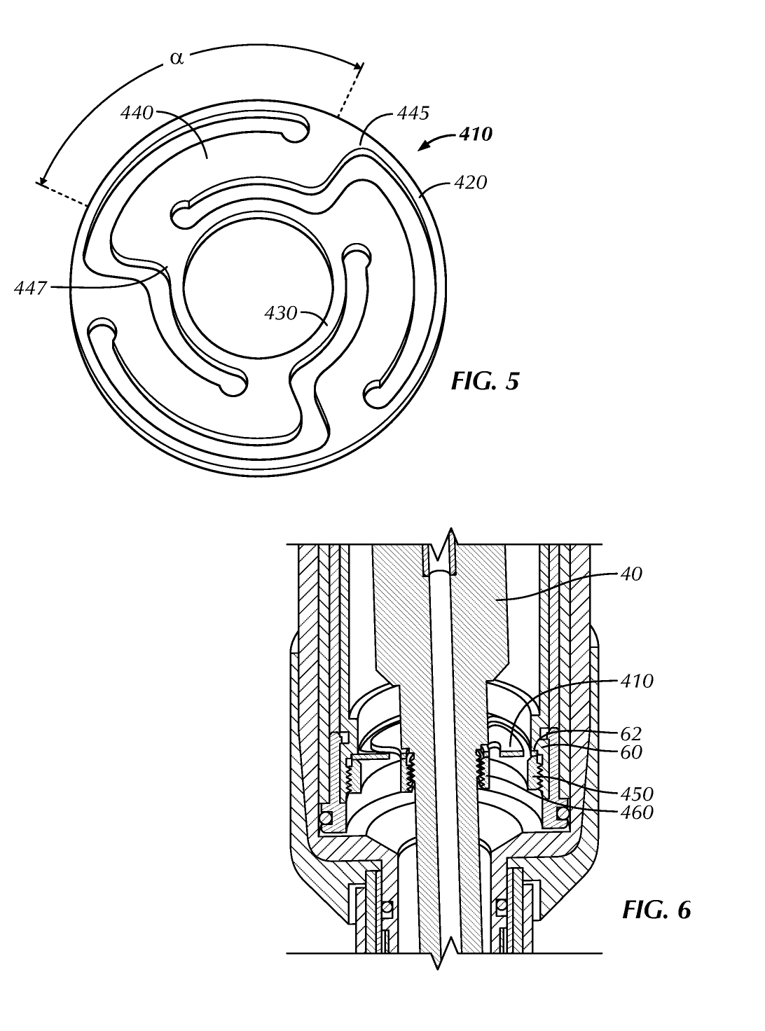

FIG. 5 is a perspective view of the flexure disk in accordance with an exemplary embodiment of the invention. The flexure disk (410) comprises an outer ring (420) and an inner ring (430). The outer ring mates with the inner body (60, not shown) of the torch (200, not shown). The inner ring mates with the wand (40, not shown). The flexure disk (410) performs the function of the fulcrum for the wand. The inner ring (430) is joined to the outer ring (420) via a plurality of arms (440). The arms arch around the space between the inner ring (430) and the outer ring (420) (the “Inner Space”). The longer the arms (α), the more deflection can be achieved between the plane of the inner and outer rings (420 & 430). However, longer arms may lose rigidity to support the wand's weight against the force of the wire, and gasses. Additionally, arms which are longer may need to have a smaller cross sectional area to completely fit within the Inner Space. Smaller cross section area increases the electrical resistance and reduces the current flow through the arms. Arms are joined to the inner ring and outer ring by fillet joints (447 & 445) to reduce stress at the joint and force flexure along the length of the arm.

FIG. 6 is a perspective sectional view of a portion of the torch body showing the improved flexure assembly in accordance with an exemplary embodiment of the invention. The wand (40) passes through the inner body (60) of the torch (200, not indicated). The wand (40) passes through the inner ring (430) of the flexure disk (410) and is secured by a lock nut (460). One skilled in the art would appreciate that other means may be utilized such as, but not limited to, cotter pins, split washers, and snap rings. The outer ring (420) of the flexure disk (410) is secured against the lower seating ledge (62) of the inner body (60) of the torch (200), and secured with a lock nut (460).

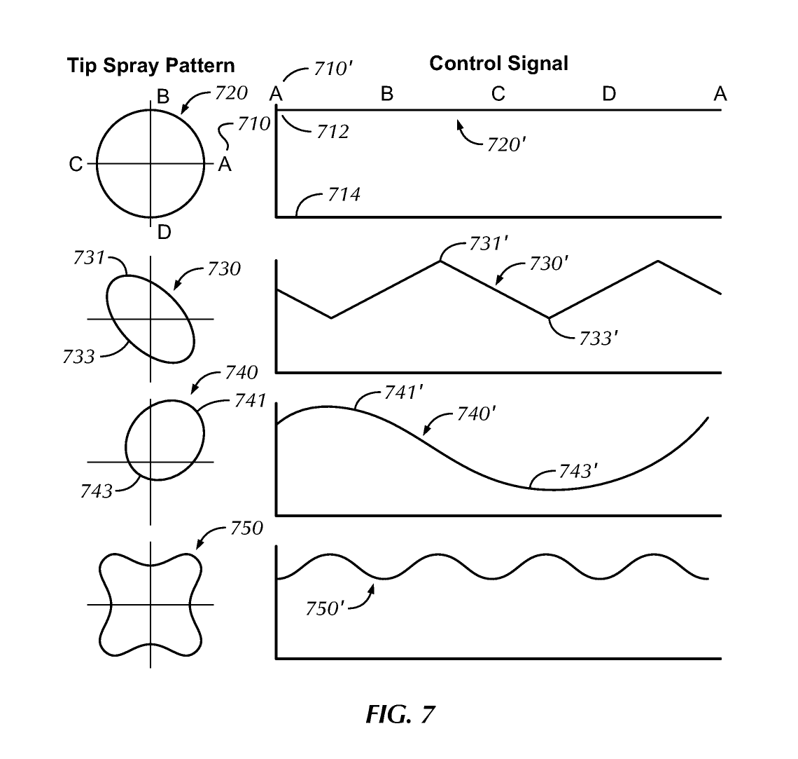

FIG. 7 shows exemplary control signals and their respective effect on the contact tip rotation patterns in accordance with an exemplary embodiment of the invention. The tip patterns (720, 730, 740, & 750) are created by the respective control signals (720′, 730′, 740′, & 750′). The angles (710) of the tip patterns (720, 730, 740, & 750) correspond to the intervals of the control signals (720′, 730′, 740′, & 750′), though in actual practice there may be some slight phase adjustment due to electronic lag. For illustrative purpose herein, the phase shift is ignored. The control signal is varied between a maximum (712) and minimum (714) power value. Increases in power results in further deflection of the contact tip, and centripetal force causes transfer of molten metals to increase in the corresponding direction.

The first pattern (720) is essentially circular as a result of the first control signal (720′) being held at a steady level. Increasing or decreasing the control signal (720′) will result in a larger or smaller radius to the pattern (720). This pattern may be utilized to evenly deposit materials across a larger weld gap in a filling procedure. The second control signal (730′) is steadily varied between a high value (731′) and a low value (733′), and cycled twice for each rotation of the contact tip. The result is an increase (731) and a decrease (733) in the radius of the tip pattern (730) at two points each pass, and thus an essentially oval shape. This pattern may be utilized to deposit more materials to opposite sides of a narrower weld gap. The third control signal (740′) is steadily varied between a high value (741′) and a low value (743′), and cycled once for each rotation of the contact tip. The result is an increase (741) and a decrease (743) in the radius of the tip pattern (740) at one point, or an offset of the weld deposits to one side of the weld line. This pattern may be utilized to deposit materials off center in a location where the environment does not allow proper centering of the torch over the weld joint. One skilled in the art would appreciate that different patterns can be utilized in different environments and for achieving different effects in the welding process.

We have now described our invention in considerable detail. It is obvious, however, that others can build and devise alternate and equivalent constructions and operations which are within the spirit and scope of our invention. Hence, we desire that our protection be limited, not by the constructions and operations illustrated, and described, but only by the proper scope of the appended claims.

The diagrams in accordance with exemplary embodiments of the present invention are provided as examples and should not be construed to limit other embodiments within the scope of the invention. For instance, heights, widths, and thicknesses may not be to scale and should not be construed to limit the invention to the particular proportions illustrated. Additionally, some elements illustrated in the singularity may actually be implemented in a plurality. Further, some element illustrated in the plurality could actually vary in count. Further, sonic elements illustrated in one form could actually vary in detail. Further yet, specific numerical data values (such as specific quantities, numbers, categories, etc.) or other specific information should be interpreted as illustrative for discussing exemplary embodiments. Such specific information is not provided to limit the invention.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. In a torch for continuous arc welding which includes a body through which an electrode wire moves, into the head end of the body and from the base end thereof, and means to produce a wire consuming electric arc as the wire moves from the base end of the body, an elongated wand within the body having a head end within the body and a base end at the base end of the body, an axial passageway from the head end to the base end through which the electrode wire moves, and a contact tip at the base end with the arcing end of the wire being extended therefrom; and a rotation means adapted to move the wand and the arcing end of the wire in a precise path and including a motor within the body adjacent to the head end of the body and having a tubular shaft in substantial alignment with the wand, with the electrode wire being extended through the motor shaft and into the wand passageway, a rotor head having an eccentric mount means is mounted on the motor shaft and the head end of the wand is carried in the eccentric mount means to move in a circular path as the motor shaft rotates the rotor head, and the diameters of the passageway's through the motor shaft and wand, with respect to the eccentricity of the mount means, are sufficient to permit movement of the electrode wire from the motor shaft and into the wand, the improvement comprising:
the eccentric mount being adjustable between a plurality of settings.

2. The torch defined in claim 1 wherein the eccentric mount is further configured to be adjusted via a rotary motor interfaced with the adjustable portion of the mount.

3. The torch defined in claim 2 wherein the rotary motor is controllable remotely via a control signal.

4. The torch defined in claim 1 wherein the eccentric mount is further configured to be adjusted via a solenoid interfaced with the adjustable portion of the mount.

5. The torch defined in claim 4 wherein the solenoid is controllable remotely via a control signal.

6. The torch defined in claim 1 further comprising:
a frictionless fulcrum allowing rotational oscillation of the wand.

7. The torch defined in claim 6 wherein the frictionless fulcrum is electrically conductive.

8. The torch defined in claim 1 wherein the control signals for the motor, and the electrode wire are juxtaposed in a single entry point on the torch.

9. The torch defined in claim 8 wherein the single entry point further allows passage of shielding gas into the torch body.

10. The torch defined in claim 9 wherein the shielding gas in the torch body further passes around the motor to provide cooling thereof.
